(19) United States
(12) Patent Application Publication
(10) Pub. No.: US 2021/0120601 A1
(43) Pub. Date: Apr. 22, 2021

(54) PAIRING METHODS AND DEVICES

(71) Applicant: Orange, Paris (FR)

(72) Inventors: François Boudet, CHATILLON CEDEX (FR); Hosni Majdoub, CHATILLON CEDEX (FR)

(21) Appl. No.: 17/076,362

(22) Filed: Oct. 21, 2020

(30) Foreign Application Priority Data
Oct. 22, 2019 (FR) 1911781

(51) Int. Cl. H04W 76/14; H04W 4/80; H04W 76/11

(52) U.S. Cl. CPC H04W 76/14; H04W 76/11; H04W 4/80

(57) ABSTRACT

A method is described of pairing between an electronic transaction terminal and a user terminal. The method may be performed by the electronic transaction terminal, and may include transmitting an identifier of the electronic transaction terminal to said user terminal, over a near-field channel using electromagnetic wave conduction capabilities of the body of the user, when the user brushes the electronic payment terminal. The method may also include receiving, over a radio channel that is separate from the near field channel, an item of data from said user terminal, and, upon a determination that the data received over the radio channel includes the transmitted identifier, pairing with the user terminal.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to French Patent Application No. 1911781, filed Oct. 22, 2019, the disclosure of which is hereby incorporated by reference in its entirety.

### BACKGROUND

### Technical Field

The disclosed technology relates to pairing with regard to setting up point-to-point radio communication when several devices are likely to be eligible for the communication.

### Description of the Related Technology

To achieve point-to-point radio communication, for example according to Bluetooth technology, it is not always easy to select one terminal from several. In the case of a wireless payment transaction, for example, in a supermarket, it is often the case that N terminals, hereafter referred to as “Electronic Transaction Terminals”, or “TTEs”, are faced with M users having terminals which are all capable of setting up a communication with one of the TTEs. Such a case can also arise for other radio technologies (Wi-Fi, Li-Fi) intended to be used in point-to-point mode between two terminals, or between a TTE and a terminal.

To perform a correct pairing between the user terminal and its TTE, question-answer-based exchange techniques may be used, which the user must validate to connect his/her terminal to another. However, this solution is complex to implement and difficult for the user.

Methods involving adapting the Bluetooth communication distance are also known. However, this distance estimation relies notably on transmission power levels of mobile terminals, which vary from one mobile to another.

Patent application WO 2004/028088 A2 of the applicant provides a solution to select one wireless device among several, from a terminal or reader (TTE). It is proposed to use a biometric characteristic of the user to establish the link between this user and the personal device, or terminal, which is attached to him/her.

However, in this case, the biometric characteristic of the user of the terminal must have been recorded in advance in the terminal, and must have been stored in the TTE. This is restrictive, in particular for the TTE.

Therefore, a need exists to improve implementations of such technology.

### SUMMARY

The disclosed technology improves the state of the art.

In one broad aspect, the disclosed technology relates to a method of pairing between a first terminal, referred to as “electronic transaction terminal”, and a second terminal of a user, referred to as “user terminal”, the method comprising, on the electronic transaction terminal, the following steps:
transmitting an identifier of the electronic transaction terminal to said user terminal, over a communication channel using electromagnetic wave conduction capabilities of the body of the user, referred to as “near field channel”, when the user brushes the electronic transaction terminal;
receiving, over a radio channel that is separate from the near field channel, an item of data from said user terminal; and
if the data received over the radio channel includes the transmitted identifier, pairing with said user terminal.

Advantageously, embodiments of the disclosed technology provide for automatically selecting one terminal among several. In some specific embodiments, the electronic transaction terminal, or TTE, transmits an identifier which it knows and which belongs only to it, thereby enabling it to be differentiated from other TTEs. In return, the TTE need simply receive the identifier that it had transmitted for it to be able to pair with the terminal which had transmitted the identifier, in order to proceed with the transaction. Thus, the TTE cannot be mistaken about the terminal, since another user having a second terminal, even if it is within its radio field, will not brush the TTE at the same time as the first user. Only the terminal of the first user which has touched/brushed the TTE can therefore be recognized by the TTE. Correspondingly, if two TTEs are in the radio field of the terminal, they both receive the identifier, but only the TTE which has transmitted this identifier can recognize it. This method therefore provides for pairing, uniquely and without a risk of error, a single TTE with a single terminal. The transaction can then take place between the correct TTE and the correct terminal. The selection method is extremely simple since the user can merely brush the TTE without needing a biometric identification or a direct presentation of the terminal to the TTE (the terminal can remain in his/her pocket, bag, etc).

The term “Pairing” refers to the operation of preparing two terminals for point-to-point bidirectional communication. This can involve a technology such as Bluetooth, Wi-Fi, Li-Fi or any other technology suitable for establishing a point-to-point wireless bidirectional link.

The term “electronic transaction terminal” refers to any communication terminal suitable for communicating point-to-point with another communication terminal over a radio link in order to perform an electronic transaction. This can be an electronic terminal, an entrance scanner, a reader in a shop, a connected object, etc.

There is no limit relating to the term “electronic transaction”, which simply refers to an exchange of electronic data between the user terminal and the TTE. This can be a transaction for payment, authentication, unlocking, etc. The TTE includes at least one near field module and is suitable for transmitting its identifier over a compatible near field channel through the body of the user (Intra-Body Communication—IBC). The TTE is moreover capable of establishing point-to-point communication with the user terminal.

The term “identifier” refers to an item of digital data which provides for differentiating one TTE from another TTE.

The phrase “using electromagnetic wave conduction capabilities of the body of the user” refers to an IBC channel. Recently, novel wireless communication techniques have emerged, using the human body as a channel. In these technologies, grouped together under the generic term IBC (Intra-Body Communication) or BCC (Body Channel Communication), the human body acts as a conductor to transmit information from one point to another. More particularly of interest in this context are methods based on coupling by induction, also often referred to as “near field”, or NF, methods which are suitable for proximity-based communication, and which do not necessarily require physical contact with the device. The term “proximity” refers to a distance in the order of a few centimeters. Near field communication, usually known by the abbreviation “NFC”, based mainly on the ISO (International Standard Organization, also known as International Organization for Standard) standard 14443, uses wireless technologies to enable information exchange between two peripheral devices separated by a short distance. IBC forms a natural extension of these technologies. When the user brushes, or touches, the TTE, the NFC wave transmitted by the latter passes through his/her body and can be received by an IBC device itself located close to the user (his/her pocket, bag, etc). In the context of the disclosed technology, such an IBC device is associated with the user terminal.

The term “transmission” over such a channel refers to the transmission of a message which corresponds to the requirements of an IBC communication (frequency, format, etc).

The term “user terminal” refers to a portable terminal, for example a smartphone, a tablet, a laptop, a connected object, etc suitable for establishing point-to-point communication with the electronic transaction terminal and for receiving, from another IBC device, the identifier of the TTE.

Some embodiments of the disclosed technology relate to a method of pairing between an electronic transaction terminal and a user terminal, the identifier includes at least a first item of data which is dependent on the transaction terminal and a second item of data which is dependent on the transaction.

Advantageously according to such embodiments, in addition to identifying the TTE without error (by virtue of the first field), the transaction can moreover be timestamped and/or certified via the second field; the first field can include an address of the processing terminal (MAC, URL, URI etc address); the second field can include a variable part, such as for example a date and time, and/or random data, the variable part being able to be modified after any communication pairing has succeeded.

In some embodiemnts of the disclosed technology, which may be implemented together with the previous one, a method of pairing between an electronic transaction terminal and a user terminal includes a step for receiving the identifier over the radio channel is followed by a step for canceling a pairing with another user terminal.

Advantageously according to such embodiments, if a current user terminal trying to pair has the identifier, a previous pairing with another user terminal can be chosen to be canceled in order to perform the pairing with this new terminal which has the identifier.

Correspondingly, embodiments of the disclosed technology also relate to a method of pairing between a second terminal of a user, referred to as “user terminal”, and a first terminal, referred to as “electronic transaction terminal”, the method comprising, on the user terminal, the steps of:
obtaining an identifier of the electronic transaction terminal;
transmitting, over a radio channel, the obtained identifier.

Advantageously, embodiments of methods described herein allow a user terminal to automatically select the electronic transaction device with which it must establish a transaction. Specifically, if several TTEs are within the radio range of the terminal, they are all going to receive the obtained identifier, but only the TTE which has transmitted it may recognize it and start communicating with the terminal.

According to a particular embodiment, in such a method of pairing between a user terminal and an electronic transaction terminal, the identifier is received from an external device over a radio channel.

According to this embodiment, the user terminal receives the identifier of the TTE over a radio link, for example Bluetooth Low Energy (BLE), set up with an external IBC device, such as for example a self-powered electronic board. Advantageously, the user terminal and the IBC device can be at a distance from one another (for example the IBC device is in a pocket of the user and the user terminal in his/her bag, etc) since the range of Bluetooth communication is a few meters.

According to another particular embodiment, which may be implemented as an alternative to the previous one, in such a method of pairing between a user terminal and an electronic transaction terminal, the identifier is received from an external device over a serial interface.

According to this embodiment, the user terminal receives the identifier of the TTE over a serial link, for example USB, set up with an external IBC device, such as for example a USB dongle or even the casing of the user terminal connected via USB to the user terminal. Advantageously, the IBC device does not need a battery since it can receive its power through the USB link set up with the terminal.

According to another particular embodiment, which may be implemented as an alternative to the previous ones, in such a method of pairing between a user terminal and an electronic transaction terminal, the identifier is received on a device inside the user terminal.

According to this embodiment, the user terminal comprises an IBC module. It receives the identifier of the TTE on this module and can access it directly. Advantageously, since the IBC device and the user terminal form a single entity, this solution can be more practical for the user since he/she would not need to carry two devices (a dongle and a smartphone, for example). Moreover, if the terminal is already equipped with an NFC module, which today is the case for most smartphones, a minor modification of the NFC module will be sufficient to make it compatible with IBC technology. Furthermore, the module, being internal, does not require a battery.

According to another particular embodiment, in the pairing methods presented above, the method additionally includes, before receiving the identifier over the radio channel or transmitting the identifier over the radio channel, a step involving initiating at least one bidirectional communication over said radio channel with at least one user terminal.

Advantageously, the user terminal and the TTE can initiate the radio communication before transmitting the identifier. By default, in Bluetooth, such a communication is initiated as soon as the Bluetooth modules of the two devices are active. The devices are not yet paired but they exchange data. From this moment, all the user terminals and all the TTEs set to Bluetooth mode therefore exchange all the identifiers transmitted by the TTEs. Thus, each TTE can recognize its identifier and set up a further communication with the terminal which has retransmitted its own identifier.

According to another particular embodiment, in the pairing methods presented above, the radio channel is a Bluetooth channel.

Advantageously, according to this embodiment, using a Bluetooth channel provides for secure point-to-point data communication between the TTE and the user terminal, as soon the terminals are paired.

Embodiments of the disclosed technology also relate to an electronic transaction terminal, comprising a near field transmitter, a radio transmitter, a radio receiver, a memory and a processor configured for:
transmitting an identifier of the electronic transaction terminal, over a channel using electromagnetic wave conduction capabilities of the body of a user, referred to as “near field channel”, when the user brushes the electronic transaction terminal;
receiving, over a radio channel that is separate from the near field channel, an item of data from said user terminal; and
if the data received over the radio channel includes the transmitted identifier, pairing with said user terminal.

Embodiments of the disclosed technology also relate to a user terminal, comprising at least a transmitter, a receiver, a memory and a processor configured for:
obtaining an identifier of an electronic transaction terminal;
transmitting, over a radio channel, the obtained identifier.

According to a particular embodiment, such a user terminal comprises a near field receiver suitable for receiving the identifier of the electronic transaction terminal via a channel using electromagnetic wave conduction capabilities of the body of the user.

Embodiments of the disclosed technology also relate to a near field device comprising at least a transmitter, a near field receiver, a memory and a processor configured for:
receiving an identifier of an electronic transaction terminal via a channel using electromagnetic wave conduction capabilities of the body of a user, referred to as “near field channel”;
transmitting the received identifier via a second communication channel.

Embodiments of the disclosed technology also relate a system comprising:
at least one electronic transaction terminal as described previously, and
at least one user terminal as described previously, and
at least one near field device as described previously,

the system being characterized in that, when the user carrying the user terminal brushes the electronic transaction terminal, the identifier of the electronic transaction terminal is transmitted to the near field device via the channel using electromagnetic wave conduction capabilities of the body of the user, and then transmitted from the device to the terminal via the second communication channel of the device.

Embodiments of the disclosed technology also relate to a system comprising:
at least one electronic transaction terminal as described previously, and
at least one user terminal as described previously, including a near field receiver,

the system being characterized in that, when the user carrying the user terminal brushes the electronic transaction terminal, the identifier of the electronic transaction terminal is transmitted via the channel using electromagnetic wave conduction capabilities of the body of the user and received by the near field receiver of the user terminal.

Embodiments of the disclosed technology also relate to a computer program including instructions for implementing one of the pairing methods above according to any one of the particular embodiments described previously, when said program is executed by a processor. The pairing method on the user terminal or on the processing terminal can be implemented in various ways, notably in wired or software form.

This program can use any programming language and be in the form of source code, object code or a code intermediate between source code and object code, such as in a partially compiled form or in any other desirable form. The computer program may be stored in a memory of a computer comprising a processor.

Embodiments of the disclosed technology also relate to a recording medium or data medium readable by a computer, and including instructions of a computer program as mentioned above. The abovementioned recording medium can be any entity or device capable of storing the program. For example, the medium can include a means of storage such as a ROM, for example a CD-ROM or a microelectronic circuit ROM, or a magnetic recording means, for example a hard disk. On the other hand, the recording medium can be a transmittable medium such as an electrical or optical signal, which can be conveyed via an electrical or optical cable, by radio or by other means. The program according to the disclosed technology can in particular be downloaded over an Internet type network.

Alternatively, the recording medium can be an integrated circuit in which the program is incorporated, the circuit being adapted to execute or to be used in the execution of the method in question.

### BRIEF DESCRIPTION OF THE DRAWINGS

Other features and advantages of the disclosed technology will become clearer upon reading the following description of particular embodiments, which are given by way of simple illustrative and nonlimiting examples, and from the appended drawings.

FIG. 1 illustrates an exemplary implementation environment of for payment transactions performed between an electronic transaction terminal and a portable device.

FIG. 2 illustrates an exemplary implementation environment of the disclosed technology.

FIG. 3 represents steps of an exemplary embodiment of a method for setting up an electronic transaction.

FIG. 4 represents an exemplary embodiment of the architecture of an electronic transaction terminal.

FIG. 5 represents an exemplary embodiment of the architecture of a terminal of a user and an associated near field device.

### DETAILED DESCRIPTION

The disclosed technology can enable automatic pairing, following a deliberate gesture by a user, for a further communication between a master terminal, also referred to herein as the “TTE”, and the terminal of the user, also referred to herein as the “user terminal”. Once paired, bidirectional communication can be set up between the TTE and the terminal, for example to carry out a payment, a transaction, etc. The user carries, in addition to his/her terminal, an electronic device suitable for communicating via his/her body, according to the technology referred to as “Intra-Body Communication”, or as the abbreviation “IBC”. This electronic device can take the form of a chip card type electronic board, or a dongle, or a casing enclosing the user terminal, or be integrated in the user terminal or in another terminal such as, for example, a connected object. In all cases, this IBC device is suitable for communicating with the terminal over a wired or wireless channel. When the user brushes the TTE with which he/she wishes to communicate, a message is transported from the TTE to his/her IBC device, which can for example be in his/her pocket. This message, which includes an identifier of the TTE, is retransmitted to the terminal, which can thence return this identifier to the TTE for a pairing. Thus, another terminal cannot be paired, even if it is within the field of the TTE. Furthermore, another TTE cannot pair with this terminal, since it does not recognize its identifier. Therefore, a reliable pairing is established between the TTE and the terminal, without the risk of mistakes.

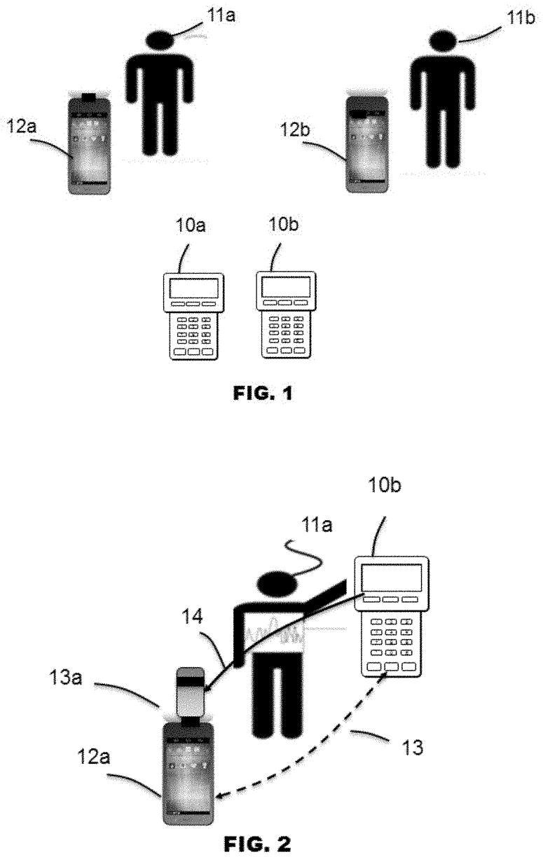

FIG. 1 illustrates an exemplary embodiment of an implementation environment for payment transactions performed between an electronic transaction terminal and a portable device.

A payment transaction must be performed between an electronic transaction terminal TTE (10b) and a portable device, hereafter called “user terminal” (12a), of a user (11a), for example a smartphone. However, the environment contains two terminals (12a, 12b) of two users (11a, 11b), and two TTEs (10a, 10b). To that extent, conventional Bluetooth pairing cannot function simply. If the TTE 10b initiates a pairing, the terminal which responds first will be paired with it. Conversely, if the terminal 12a tries to pair, it can be associated in error with the TTE 10a.

FIG. 2 illustrates an exemplary implementation environment of the disclosed technology.

The user (11a) carrying the terminal (12a), for example a smartphone, additionally carries, according to this embodiment, an IBC device (13a) associated with his/her terminal. According to the example illustrated, the IBC device (13a) is in the form of a USB dongle connected to the terminal via its USB port. Naturally, other examples are possible (Thunderbolt dongle, casing equipped with a USB connector, IBC board communicating wirelessly with the terminal, for example in Bluetooth or NFC mode, IBC module inside the terminal, etc). When the user brushes the surface of the TTE (10b) on which he/she must perform the transaction, a pairing signal is transmitted via a channel (14) using the conduction capabilities of the human body according to near field IBC communication. The data is received via the human body of the user (11a) by the IBC device, and then retransmitted to the user terminal (12a) and can for example be stored in a memory of the user terminal.

The user terminal (12a) according to the disclosed technology is therefore suitable for receiving data of a portable IBC device (13a), itself naturally suitable for receiving radio carrier waves, via an antenna, through the body of the user (11a) who acts as a communication channel. To that end, the IBC device (13a) associated with the terminal (12a) is situated in immediate proximity to the user (11a), without necessarily being in direct contact with him/her. For example, the IBC device (13a) is placed inside a pocket or bag carried on the user. In these configurations, it is estimated that the IBC device (13a) is not apart by more than a few centimeters from the body of the user (11a). The distance is for example less than 5 cm.

The IBC device (13a) can communicate with the terminal 12a via a Bluetooth link (preferably Bluetooth Low Energy—BLE) or Li-Fi, Wi-Fi, NFC, etc. In that case, it is equipped with one or more batteries to allow autonomous operation. It can communicate also with the terminal 12a via a wired link, for example USB or Thunderbolt, in which case it can obtain its power via the wired link. According to another example, the mobile terminal integrates the IBC device. It can for example be equipped natively with an electronic module, referred to as “IBC module”, including an NFC antenna adapted for IBC mode in order to receive modulated electrical signals in the form of an electromagnetic wave through the body of the user when the user is in immediate proximity to the TTE (11b).

According to the particular embodiment illustrated in FIG. 2, pairing data is transmitted between the TTE (10b) and the terminal (12a) of the user via the IBC channel (14), and then the USB link of the IBC device. This data corresponds to connection data for the terminal (12a) to then establish bidirectional communication (13) between the terminal (12a) and the TTE (10b). It notably includes an identifier of the TTE.

The term “identifier” refers to an item of digital data which provides for unambiguously differentiating between one TTE and another TTE. As introduced previously, it can include an address followed by a variable field containing the date/time and random data. The variable part may be modified after any successful communication pairing.

According to the example embodiment illustrated in FIG. 2, the terminal (12a) moreover includes means for communicating over a second channel (13) with the TTE. The use of such a channel (13) enables higher data rates and transmission speeds than for IBC, and bidirectional communication. This communication (13) can be set up according to any embodiment within the capabilities of the person skilled in the art, for example according to Bluetooth, Wi-Fi, Li-Fi, DECT, etc technology.

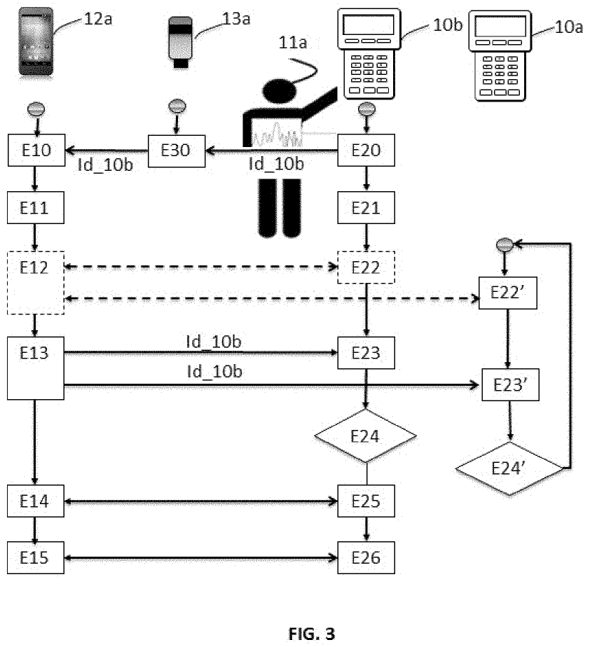

FIG. 3 represents steps of an exemplary embodiment of a method for setting up an electronic transaction.

This embodiment illustrates the pairing of the terminal 12a with the TTE 10b in order to perform for example a financial transaction.

During an initial step, symbolized by the user's arm directed towards the TTE 10b, the user brings his/her hand close to the TTE to brush it (or touch it). It is assumed that the TTE is set to a mode in which it is permanently transmitting an electromagnetic field. This mode is called, in a known manner, “reader” mode.

During step E20, proximity (in the NFC sense) is established with the hand of the user, forming a near field communication channel; a message, prepared and broadcast by the TTE, is transmitted via the body of the user. This message notably contains an identifier of the TTE as described previously (containing for example an address, a timestamp, random data, etc) which provides for differentiating it from the other TTEs.

During a step E30, the IBC device (13a) which is close to the body of the user, receives the message containing the identifier (Id_10b). The IBC device retransmits this message to the user terminal with which it is associated. As mentioned previously, this retransmission can be carried out:
directly if the device is integrated in the terminal (it then receives it, for example, via an IBC/NFC component and can be obtained directly through memory);
via a USB (respectively Thunderbolt) interface if the IBC device takes the form of a USB (respectively Thunderbolt) dongle, or a casing which can be connected by USB to the user terminal via for example a connector which connects to the USB module of the user terminal;
via a radio link (Bluetooth or Wi-Fi/Li-Fi, for example, or NFC) if the IBC device, taking for example the form of an electronic board, has such an interface and is correctly paired with the user terminal;
etc.

During a step E11, the identifier received by the user terminal at step E10 is stored.

During a step E12, the terminal initiates communication with nearby TTEs (i.e. those which are within range of its radio module). For example, it activates its Bluetooth or Wi-Fi module.

According to a variant, the user terminal 12a transmits the identifier to a server which will retransmit it to the TTEs.

During steps E22, E22′, both TTEs agree to set up a communication link with the user terminal. For example, they activate their Bluetooth or Wi-Fi module.

During a step E13, the terminal transmits (broadcasts) to the TTEs the identifier of the TTE which it has obtained beforehand and possibly stored. The TTEs which are both within radio range (Bluetooth) of the terminal, both receive the identifier during steps E23, E23′.

During steps E24, E24′, the two TTEs 10b and 10a, respectively, test the received identifier. If the received identifier is identical to the one which it had transmitted, which is the case for the TTE 10b at step E24, the TTE proceeds with pairing with the terminal during steps E25/E14; such a pairing process, for example Bluetooth, is known and will not be described hereafter. If the received identifier is different from the one which it had transmitted, which is the case for the TTE 10a at step E24′, the TTE does not proceed with the pairing and stops the procedure.

According to a variant, during these steps, the TTE can decide to unpair another terminal which was paired with it. It can also delay the pairing if it is performing another operation with another terminal.

During steps E15 and E16, the transaction can be performed, for example a payment in a supermarket, or the opening of a door, etc.

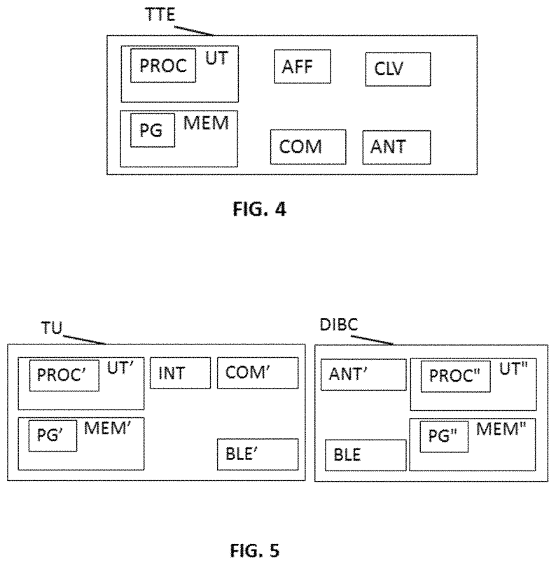

FIG. 4 represents an exemplary embodiment of the architecture of an electronic transaction terminal.

According to this particular embodiment, the transmission device TTE has the conventional architecture of a computer, and notably comprises:
a memory MEM, a processing unit UT equipped for example with a processor PROC and driven by the computer program PG stored in the memory MEM.
the computer program PG comprises instructions to implement the steps of the pairing method as described previously, when the program is executed by the processor PROC. Upon initialization, the code instructions of the computer program PG are for example loaded into a memory before being executed by the processor PROC. The processor PROC of the processing unit UT notably implements the steps of the pairing method on the TTE according to any one of the particular embodiments described with reference to FIG. 3, according to the instructions of computer program PG.
a near field communication module ANT notably comprising an antenna suitable for transmitting signals over the radio channel and possibly via the human body and a modulator intended to adapt a digital signal produced by the processor to a modulated electrical signal, intended to be transmitted via the antenna over an IBC channel. The modulation operation carried out by the modulator is for example an amplitude modulation: the signal is an amplitude-modulated 13.56 MHz signal. The disclosed technology is not however limited to this type of modulation. In another example embodiment, the modulation is a frequency modulation, less sensitive to parasitic effects, or, a phase modulation. In all cases, the signal must be adapted to the IBC communication channel, both for the hardware and protocol aspects. According to a particular embodiment of the disclosed technology, the device TTE is equipped with a contact surface, not represented, suitable for reacting to the immediate proximity of the user (contact, near-contact, brushing, etc). In the example described here, this surface corresponds to the antenna, such that a modulated electrical signal transmitted via the antenna is suitable for being conveyed by the body of the user which is close to the surface. In an example embodiment, the antenna can be integrated in the surface. The surface is arranged so as to cooperate with the processing unit UT in order to implement the step for transmitting the identifier of the TTE.
a Bluetooth (or alternatively Wi-Fi, NFC, etc) communication module COM notably intended to exchange data with the user terminal.
According to a particular embodiment, the transmission device TTE comprises a display module AFF, for example a screen, and a user interaction module CLV, for example a numeric keypad.

FIG. 5 represents an exemplary embodiment of the architecture of system including user terminal (TU) and an IBC device (DIBC) of a user.

It is recalled that the IBC device can be either integrated in or associated with the terminal (in USB, Bluetooth, etc mode). According to this particular embodiment, the IBC device is separated from the terminal and has the conventional architecture of an electronic board, and notably comprises:
a memory MEM″, a processing unit UT″ equipped for example with a processor PROC″ and driven by the computer program PG″ stored in the memory MEM″.
the computer program PG″ comprises instructions to implement the steps of the method for receiving an item of IBC data and for retransmission to the user terminal as described previously, when the program is executed by the processor PROC″. Upon initialization, the code instructions of the computer program PG″ are for example loaded into a memory before being executed by the processor PROC″.
a near field communication module ANT′ notably comprising an IBC antenna suitable for receiving signals via the human body, such that a modulated electrical signal, and which is possibly transported by the body of the user, is suitable for being received by the antenna, a demodulator intended to receive via the antenna a modulated electrical signal and intended to convert it to a digital signal intended to be transmitted to the processing unit UT″, and the software components (firmware, etc) required to implement IBC communications.
a Bluetooth Low Energy (or alternatively Wi-Fi, NFC, etc) radio communication module BLE notably intended to transmit data, including the identifier of the TTE, to the user terminal.

According to a particular embodiment, the device DIBC is contained in the user terminal TU, for example a smartphone. In that case, the interfaces BLE and BLE′ become useless.

According to this particular embodiment, the terminal TU has the conventional architecture of a computer, and notably comprises:
a memory MEM′, a processing unit UT′ equipped for example with a processor PROC′ and driven by the computer program PG′ stored in the memory MEM′.
the computer program PG′ comprises instructions to implement the steps of the pairing method as described previously, when the program is executed by the processor PROC′. Upon initialization, the code instructions of the computer program PG′ are for example loaded into a memory before being executed by the processor PROC′. The processor PROC′ of the processing unit UT′ notably implements the steps of the pairing method on the terminal according to any one of the particular embodiments described with reference to FIG. 3, according to the instructions of the computer program PG′.
a Bluetooth Low Energy (or Wi-Fi, Li-Fi, etc) radio module BLE′ notably intended to exchange data with the module BLE of the device DIBC.
a communication module COM′ enabling the user terminal TU to set up communication with the TTE with which to pair and later perform the transaction.

According to a particular embodiment, the terminal TU comprises a user interaction module INT, for example a touchscreen.

According to a particular embodiment, the terminal TU is contained in a smartphone.

It goes without saying that the embodiment which has been described above has been given purely by way of indication and is not at all limiting, and that a number of modifications can easily be brought about by the person skilled in the art without thereby departing from the scope of the disclosed technology.

For example, the received pairing method and device can be applied to a communication between an audio reproduction terminal (audio headset, earphone, etc) and several audio processing devices (smartphone, tablet, hi-fi system, etc) playing the role of TTE according to the disclosed technology. A first user wearing an audio headset and holding an associated IBC device can brush the hi-fi system in order to receive the sound source from it. A second user wearing an earphone may for their part brush the smartphone in order to pair with it.

What is claimed is:

1. A method of pairing between a an electronic transaction terminal and a user terminal, the method being performed by the electronic transaction terminal, the method comprising:
transmitting an identifier of the electronic transaction terminal to the user terminal over a near field channel using electromagnetic wave conduction capabilities of the body of the user, when the user brushes the electronic transaction terminal;
receiving, over a radio channel that is separate from the near field channel, an item of data from the user terminal; and
upon a determination that the data received over the radio channel includes the transmitted identifier, pairing with the user terminal.

2. The method of claim 1, wherein the identifier includes at least a first item of data which is dependent on the transaction terminal and a second item of data which is dependent on the transaction.

3. The method of claim 1, additionally comprising, after receiving the identifier over the radio channel, canceling a pairing with another user terminal.

4. The method of claim 1, additionally comprising, prior to receiving the identifier over the radio channel, initiating at least one bidirectional communication over the radio channel with at least one user terminal.

5. A method of pairing between a user terminal and an electronic transaction terminal, the method being performed by the user terminal, the method comprising:
obtaining an identifier of the electronic transaction terminal; and
transmitting, over a radio channel, the obtained identifier.

6. The method of claim 5, wherein the identifier is received from an external device over a radio channel.

7. The method of claim 5, wherein the identifier is received from an external device over a serial interface.

8. The method of claim 5, wherein the identifier is received on a device inside the user terminal.

9. The method of claim 5, additionally comprising, prior to transmitting the identifier over the radio channel, initiating at least one bidirectional communication over the radio channel with at least one user terminal.

10. An electronic transaction terminal configured to implement the method of claim 1, the electronic transaction terminal comprising a near field transmitter, a radio transmitter, a radio receiver, a memory, and a processor which are configured to implement the method of claim 1.

11. A user terminal configured to implement the method of claim 5, the user terminal comprising a transmitter, a receiver, a memory and a processor which are configured to implement the method of claim 5.

12. The user terminal of claim 11, further comprising a near field receiver configured to receive the identifier of the electronic transaction terminal via a channel using electromagnetic wave conduction capabilities of the body of the user.

13. A near field device comprising a transmitter, a near field receiver, a memory, and a processor, the near field device being configured to:
receive an identifier of an electronic transaction terminal via a near field channel using electromagnetic wave conduction capabilities of the body of a user; and
transmit the received identifier via a second communication channel.

14. A system for wireless pairing of terminals, the system comprising:
the electronic transaction terminal of claim 9, a user terminal comprising a transmitter, a receiver, a memory and a processor, the user terminal being configured to:
obtain an identifier of the electronic transaction terminal; and
transmitting, over a radio channel, the obtained identifier; and
a near field device comprising a transmitter, a near field receiver, a memory, and a processor, the near field device configured to:
receive the identifier of an electronic transaction terminal via a near field channel using electromagnetic wave conduction capabilities of the body of a user; and
transmit the received identifier via a second communication channel;
wherein, when the user carrying the user terminal brushes the electronic transaction terminal, the identifier of the electronic transaction terminal is transmitted to the near field device via the channel using electromagnetic wave conduction capabilities of the body of the user, and tis hen transmitted from the near field device to the terminal via the second communication channel of the device.

15. A system for wireless pairing of terminals, the system comprising:
the electronic transaction terminal of claim 9; and
a user terminal comprising a transmitter, a receiver, a memory and a processor, the user terminal being configured to:
obtain an identifier of the electronic transaction terminal; and
transmit, over a radio channel, the obtained identifier;
wherein, when the user carrying the user terminal brushes the electronic transaction terminal, the identifier of the electronic transaction terminal is transmitted via the channel using electromagnetic wave conduction capabilities of the body of the user and received by the near field receiver of the user terminal.

16. A non-transitory, computer-readable storage medium having stored thereon instructions which, when executed by a processor, cause the processor to perform the method of claim 1.

17. A non-transitory, computer-readable storage medium having stored thereon instructions which, when executed by a processor, cause the processor to perform the method of claim 5.
